(19) United States
(12) Patent Application Publication
(10) Pub. No.: US 2023/0013866 A1
(43) Pub. Date: Jan. 19, 2023

(54) DISPOSABLE PROPHY ANGLE

(71) Applicant: Pac-Dent, Inc., Brea, CA (US)

(72) Inventors: Daniel Wang, Brea, CA (US); Xiao Yang, La Habra, CA (US)

(21) Appl. No.: 17/375,990

(22) Filed: Jul. 14, 2021

(51) Int. Cl. A61C 17/00; A61C 17/24

(52) U.S. Cl. CPC A61C 17/005; A61C 17/24

(57) ABSTRACT

The present invention relates to a disposable dental appliance and, more particularly, a dental prophy angle used for cleaning and polishing teeth, especially, a prophy angle for holding a disposable polishing/cleaning cup-head/brush-head that is disposed after each application to a patient to prevent potential cross contamination. The disposable prophy angle for a handpiece preferably comprises an elongated tubular housing, a drive shaft, a driven gear rotor, and a prophy cup/brush-head. The tubular housing has a longitudinal and a transverse section in one integral piece with a proximal end adapted to couple to a standard dental handpiece. The housing further has an extrusion-molded socket on its top inner surface. The housing has a horseshoe-like locker to position the drive shaft gear against the driven rotor gear. The driven rotor comprises a rotor head, a rotor neck, a driven rotor gear, a cup flange, a cup neck, and a cup holder.

### TECHNICAL FIELD

The present invention relates to a disposable dental appliance and, more particularly, a dental prophy angle used for cleaning and polishing teeth, especially, a prophy angle for holding a disposable polishing/cleaning cup-head/brush-head that is disposed after each application to a patient to prevent potential cross contamination.

### BACKGROUND ART

A prophy angle is a dental appliance used in the dental profession for the cleaning and polishing of teeth. A prophy angle comprises a prophy cup/brush-head that is secured to the angle and is rotated by a driving mechanism inside the angle. In order to rotate a prophy cup/brush-head to perform the teeth cleaning and polishing work, the driving mechanism is typically implemented with a gear connection between a driving gear shaft and a driven gear rotor secured to one end of a transmission appliance. The other end of the nose cone is secured to a dental handpiece with a motor in it. The driving gear shaft is rotated by the motorized handpiece with a speed of 2,000 to 5,000 rpm. That rotation is then transferred to the driven rotor to rotate the prophy cup/brush-head.

Cross-contamination is the process by which bacteria or other microorganisms are unintentionally transferred from one substance or object to another, with harmful effect, even if the transferred amount is small or residual. Residual cross-contamination between patients is of serious concern to the public and the dental profession. This problem has received considerable attention due to the publicity of many known illnesses and diseases that may be communicated by the transfer of contaminants between patients. To combat cross contamination, disposable prophy angles are widely used and are intended for a single operation only.

Prior art prophy angles often secure the driven gears to the driving shaft with a bulky prophy angle head. Excessive bulk can cause discomfort for the patient. For example, Young Dental Manufacturing Co, LLC created a prophy angle where the prophy cup is snapped onto the head portion of the angle. The cup is locked in place using a latch. While this mechanism ensures the security of the prophy cup during vibration, it also creates a bulkier head portion. With the enlarged head portion of the prophy angle, patients will have to open their mouth wide during operation, which heavily sacrifices their experience, and at the same time causes operational difficulties for the dental professionals.

Prior art devices also secure the driven gear and the driving shaft, during high-speed vibration, with a locker on the top of the prophy angle head. For example, U.S. Pat. No. 7,255,559 discloses a disposable prophy angle with a locker on the top of the prophy angle head portion that helps to keep the gears in place during high-speed vibration. However, this mechanism causes higher level of noises during operation because the additional parts create additional noise during high-speed vibration.

Furthermore, in the prior art devices, the gears and the driving shaft are not secured in place during operation. U.S. Pat. No. 7,255,559 discloses a prophy angle with a locker on top of the head portion and a horseshoe-like locker on the housing. However, it is difficult to insure that these additional parts will be mechanically precise when assembled. Also, the cost of manufacturing these prior art prophy angles is significantly increased.

The prior art devices also comprise a prophy cup/brush-head that is assembled on the driven gear of the prophy angle. Currently, there are mainly two types of prophy angles on the market— a prophy angle with a cup-head and a prophy angle with a brush-head. The prophy angle with a cup-head has a cup-head that is assembled onto the driven gear of the prophy angle. The prophy angle with a brush-head has a cup that is assembled to the driven gear with the brushes over-molded on the cup. However, for both products, the cup assembled to the driven gear may be disconnected from the driven gear during operation due to vibration. Furthermore, on a brush-head prophy angle, the cup covers part of the brushes and, therefore, limits the visible area during operation.

Therefore, a need exists for a disposable prophy angle that is effective, economically justified, and has securely connected components. A need also exists for a prophy angle with noise reduction and that prevents cross-contamination. Such a device should be compatible with a standard connection and assure reliable and high performance operation with a high-speed handpiece.

### SUMMARY OF THE INVENTION

The present invention is a prophy angle for holding a disposable polishing/cleaning cup-head/brush-head that is disposed after each application to a patient to prevent potential cross contamination. The prophy angle preferably comprises an elongated tubular housing, a drive shaft, a driven rotor, and a mini prophy cup/brush-head.

One advantage of the present invention is that the prophy angle has a head portion significantly smaller than prior art designs. In the present invention, the size of the head portion is significantly reduced, which improves patient comfort during dental procedures as well as providing better manual manipulation of controls by dental professionals.

Another advantage of the present invention is the prophy angle has significantly reduced vibration and noise during operation. This is due to the significant reduction in the number of the parts and the weight and length of the whole instrument. This is achieved by eliminating prior art means of securing the drive shaft and the driven gear, such as, e.g., latches. Embodiments of the invention provide a prophy angle that has no locker external to and on the top of the head portion or built-in locking parts inside the head portion. This effectively reduces the vibration of the parts during operation and lead to minimal noise emanating from the prophy angle.

Another advantage is the present invention is that the gear of the prophy cup/brush-head is secured in place with minimized shifting during operation of the device. Preferably, the prophy angle has an extrusion molded socket on the top of the inner side of the prophy angle that has a radian to secure the gear of prophy cup/brush-head while said socket at the same time, provides enough flexibility for rotation of the brush-head. Further, the thickness of the said socket stabilizes the driven gear and reduces noise.

Another advantage is that the driven gear is operatively and securely connected to the drive shaft gear with certain ratios to ensure stability and limit shifting of the gears. The beveled gears of the present invention provide stability of the gears during movement. Furthermore, the number of teeth on the gears helps to further stabilize the gears. In one preferred embodiment, the number of teeth of the drive shaft gear is 10 and the number of the teeth of driven gear is 11. In another preferred embodiment, the number of teeth of the drive shaft gear is 9 and the number of the teeth of driven gear is 10.

Another advantage of the present invention is that it uses two different materials for the housing and the shaft. The housing part uses a material that is rigid enough to keep the shape of the prophy angle against the environmental change such as the temperature and the moisture. The shaft portion uses a material that is flexible enough to be driven by a handpiece while at the same time rigid enough to keep the shape against the heat generated by the rotation as well as the friction from the gears.

Another advantage is the present invention provides significant cost savings. This is achieved by reducing the number of locking parts during manufacture and assembly. Additionally, the present invention is preferably formed by extrusion molded plastic.

A further advantage is the present invention has a secured prophy cup-head/brush-head. One embodiment of the present invention includes a prophy cup that is over molded on the driven gear, which secures the cup on the prophy angle and prevents undesired disassembly of the cup during operation. Another embodiment of the present invention has brushes over molded on the driven gear, which prevents undesired disassembly of the brushes during operation and eliminates the use of a prophy cup. The elimination of the prophy cup improves visibility for the user to use of the device.

The foregoing, and other features and advantages of the invention, will be apparent from the following, more particular description of the preferred embodiments of the invention, the accompanying drawings, and the claims.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1A is a side view of a preferred embodiment of the invention;

FIG. 1B is a bottom view of a preferred embodiment of the invention;

FIG. 1C is an end cross-sectional view of a preferred embodiment of the invention;

FIG. 1D is an end view of a preferred embodiment of the invention;

FIG. 2A is a side cross-sectional view of preferred embodiment of the invention;

FIG. 2B is a side cross-sectional view of a preferred embodiment of the invention;

FIG. 3A is side view of a preferred embodiment of the prophy angle without a head;

FIG. 3B is a bottom view of a preferred embodiment of the prophy angle without a head;

FIG. 4A is a bottom cross-sectional view of a preferred embodiment of the prophy angle without a head;

FIG. 4B is a side cross-sectional view of a preferred embodiment of the prophy angle without a head portion;

FIG. 4C is an end cross-sectional view of a preferred embodiment of the prophy angle without a head portion;

FIG. 5A is a side view of a preferred embodiment of the drive shaft;

FIG. 5B is an end view of a preferred embodiment of the drive shaft;

FIG. 6A is a side view of a preferred embodiment of the driven rotor;

FIG. 6B is a side partial cross-sectional view of a preferred embodiment of the driven rotor;

FIG. 6C is a top view of a preferred embodiment of the driven rotor;

FIG. 7A is a side view of a preferred embodiment of the head portion;

FIG. 7B is a bottom view of a preferred embodiment of the head portion;

FIG. 8A is a side view of a preferred embodiment of the horseshoe-like locker;

FIG. 8B is a top view of a preferred embodiment of the horseshoe-like locker;

FIG. 9 is a top perspective view of a preferred embodiment of the invention;

FIG. 10 is a bottom perspective view of a preferred embodiment of the invention;

FIG. 11 is a top perspective cross-sectional view of a preferred embodiment of the invention; and,

FIG. 12 is a top perspective partial cross-sectional view of a preferred embodiment of the invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide disposable prophy angle.

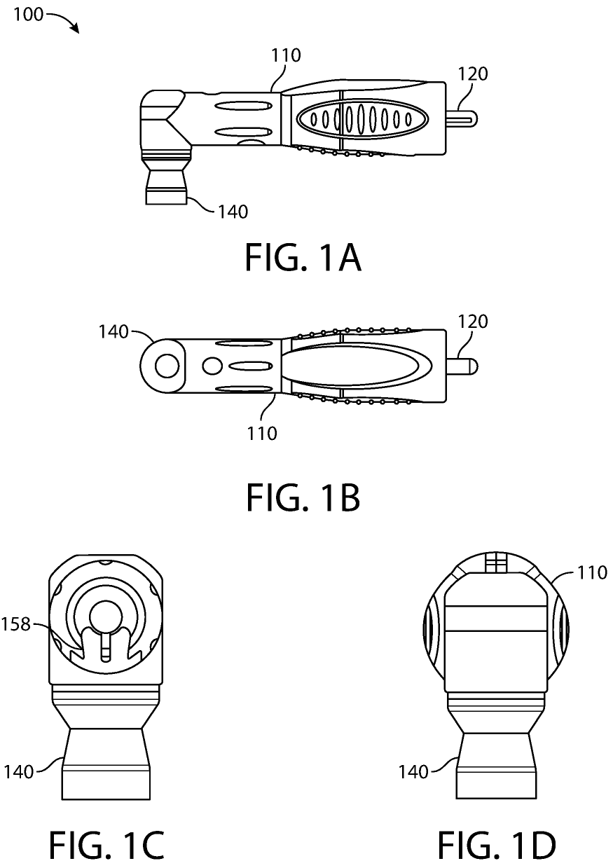

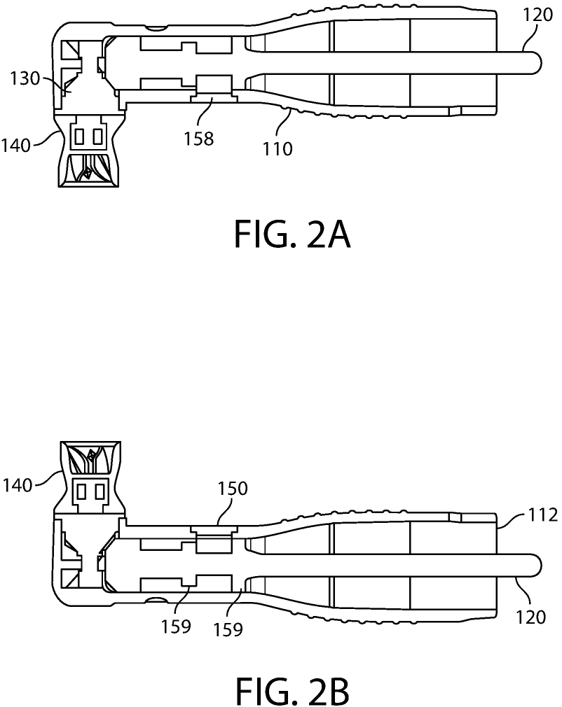

Referring now to FIGS. 1A-1D, a preferred embodiment of a disposable prophy angle 100 is shown. FIG. 1A is a side vide of a preferred embodiment of the device comprising an elongated tubular housing 110, a drive gear shaft 120, and a prophy cup/brush-head 140. FIGS. 2A and 2B are side cross-sectional views of the preferred embodiment of the device. In FIGS. 2A-2B, the drive gear shaft 120 engages the driven gear or rotor 130, which in turn drives the brush-head 140.

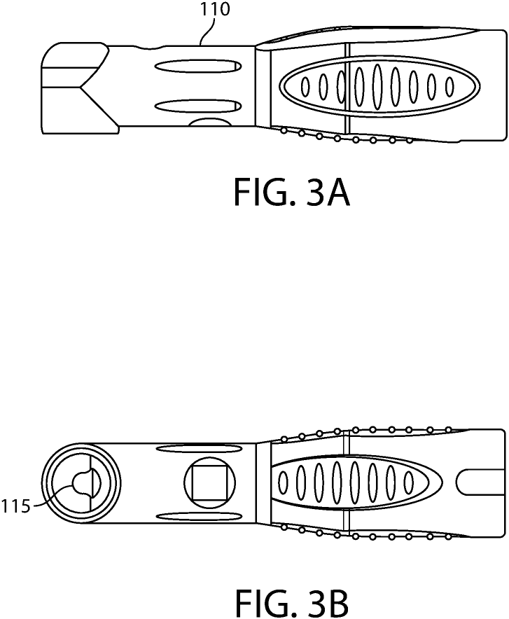

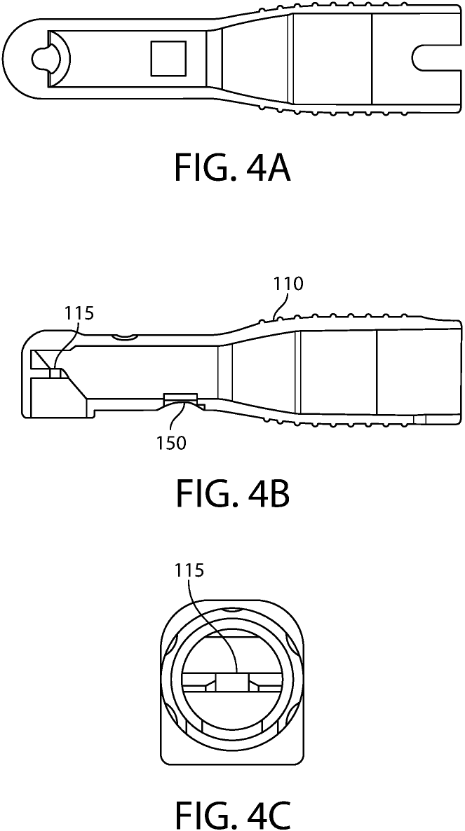

Referring now to FIGS. 3A and 3B, a preferred embodiment of the tubular housing 110 is shown. The tubular housing 110 preferably is a single integral piece with a proximal end 112 adapted to connect/couple with a standard dental (motorized) handpiece (not shown). As detailed in FIG. 3B, the top inner portion of the tubular housing 110 comprises a socket 115 that interfaces and secures the driven gear 130 of the prophy cup/brush-head 140. The socket 115 is preferably extrusion molded and minimizes shifting during operation of the device. The socket 115 preferably has an inner diameter of 4-6 mm, e.g. sufficient to secure the gear 130 of prophy cup/brush-head 140. The socket 115 also provides flexibility for rotation of the brush-head 140. Further, the thickness of the said socket stabilizes the driven gear 130 and reduces noise. Preferably, the socket 115 is 0.8 mm to 1 mm thick. The socket 115 is also shown in FIGS. 4A, 4B and 4C, namely cross-sectional views of the preferred embodiment tubular housing. The socket 115 preferably holds the gear 130 at a rotor neck 134 to secure the brush-head gear or cup holder 142 of the prophy cup/brush-head 140 in place.

The use of extrusion molded plastics for, at a minimum, the tubular housing 110 reduces the cost of the device to allow for single use/disposability to prevent cross-contamination between patients. Furthermore, the prophy cup/brush-head preferably comprises rubber.

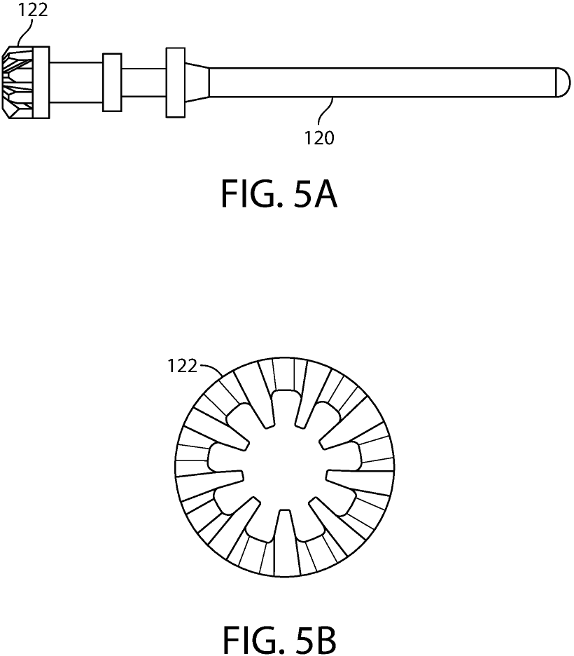

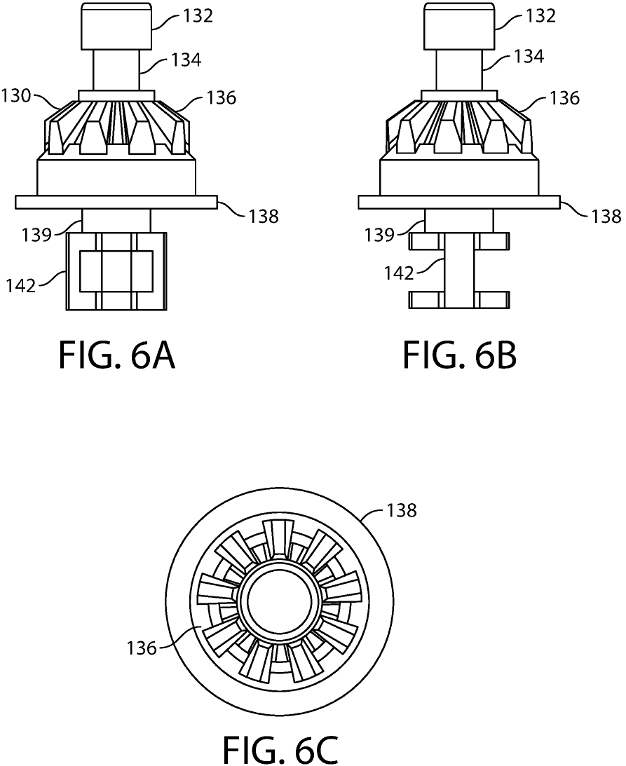

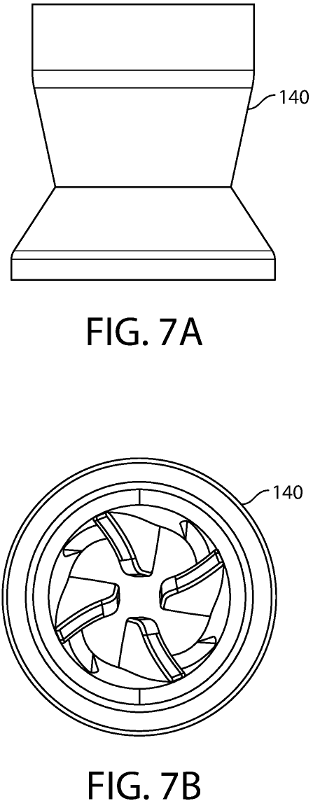

Referring now to FIGS. 5A and 5B, the drive shaft 120 is shown. The first end of the drive shaft 120 preferably comprises a drive shaft gear 122. The drive shaft gear 122 is preferably beveled for interface with driven gear 130. The driven gear or driven rotor 130 is also preferably beveled. Preferred embodiments of the driven rotor 130 are shown in FIGS. 6A-6C. The driven rotor 130 preferably comprises, a rotor head 132, a rotor neck 134, a driven gear or rotor gear 136, a cup flange 138, a cup neck 139 and a cup holder 142. Preferably, the drive shaft gear 122 has 9-10 drive shaft gear teeth and the driven gear 136 has 10-11 driven gear teeth. The prophy cup/brush-head 140 is preferably over molded on the driven gear 130 at the cup-holder 142. The prophy-cup/brush head 140 preferably has a diameter of 7 to 8 millimeters. A side view of a preferred embodiment of the head portion or prophy cup/brush-head 140 is shown in FIGS. 7A and 7B.

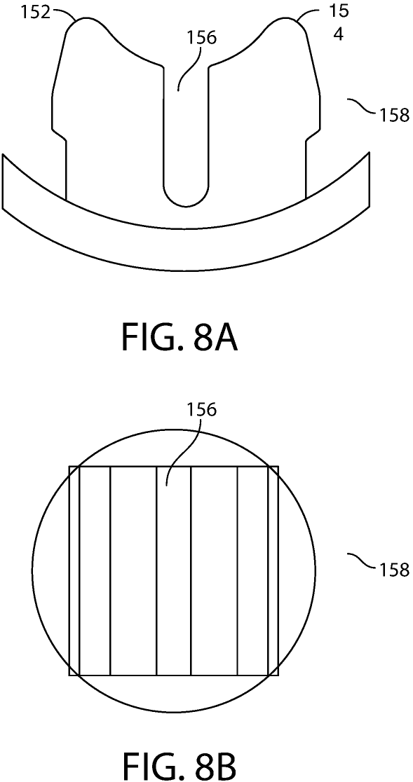

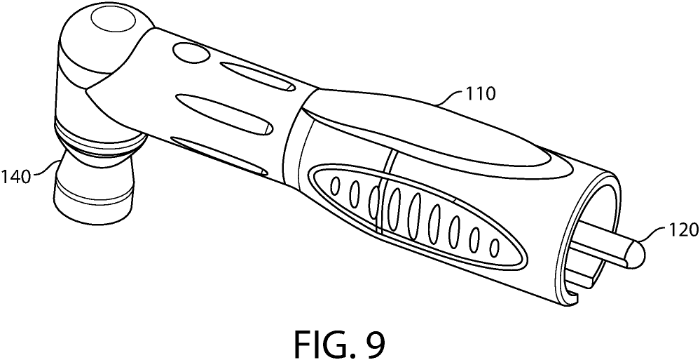

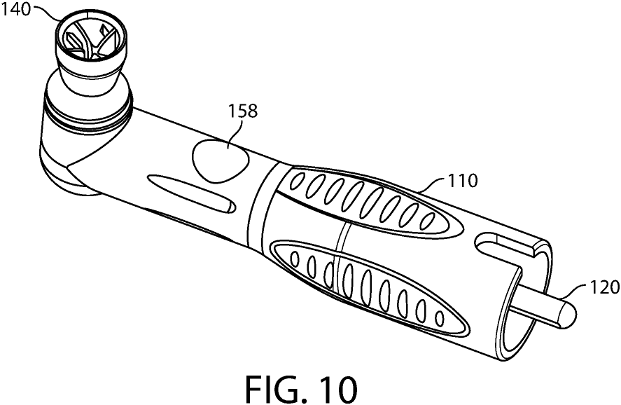

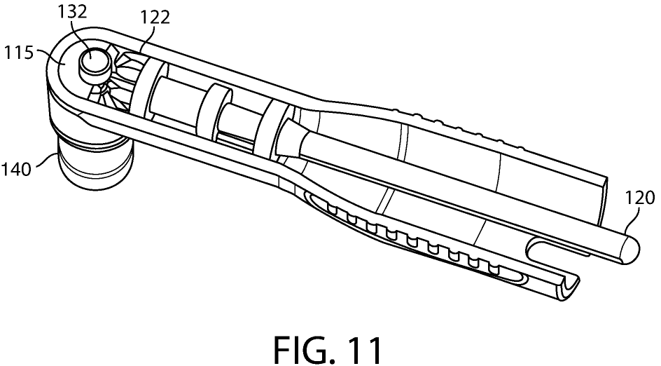

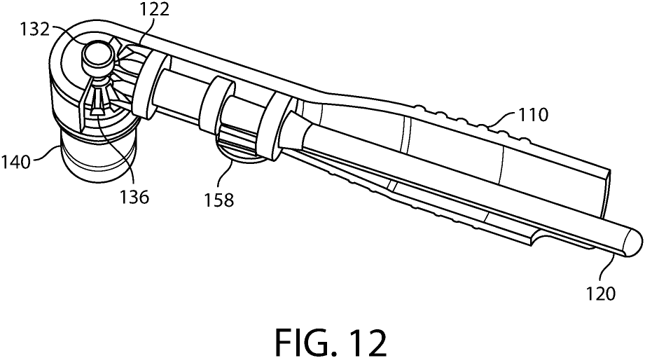

Referring back to FIG. 1C and referring to FIGS. 8A and 8B, a preferred embodiment of a horseshoe-like locker 158 is shown. The locker 158 preferably has two forks 152, 154 perpendicular to a central axis of a longitudinal axis of the tubular housing 110. The forks 152, 154 are separate by a gap 156. The gap 156 is preferably wider than the diameter of the drive shaft 120 between two positioning steps 159. The locker 158 is preferably located in slot 150 on housing 110 as shown in FIGS. 2B and 4B. The locker 158 ensures a secure axial placement of the drive shaft 120 against driven rotor 130. The drive shaft gear 122 preferably interfaces with the driven gear 136 at a 90-120 degree angle with the driven rotor’s axis. This facilitates teeth cleaning operations by allowing a dental prophylaxis angle to more easily reach all areas of a patient’s mouth. This angle also improves comfort for users with an ergonomic neutral wrist position. A preferred embodiment of this invention shown in FIGS. 9-11 shows this angle.

Thus, an improved disposable prophy angle is described above that has the previously disclosed advantages. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A disposable prophy angle for a handpiece, comprising:
an elongated tubular housing, a drive shaft, a driven gear rotor, and a prophy cup/brush-head;
said tubular housing having a longitudinal and a transverse section in one integral piece, with a proximal end adapted to couple to a standard dental handpiece;
said tubular housing further having an inner surface with a top comprising an extrusion molded socket;
said tubular housing further having a horseshoe-like locker;
said drive shaft comprises a drive shaft gear, and two positioning steps to receive the horseshoe-like locker;
said driven rotor comprises a rotor head, a rotor neck, a driven rotor gear, a cup flange, a cup neck, and a cup holder; and,
where the drive shaft, drive shaft gear, the driven rotor gear and the horseshoe-like locker comprise a coupling mechanism to maintain continuous engagement of the drive shaft gear and the driven rotor gear during operation.

2. The prophy angle of claim 1, wherein the said prophy cup/brushhead is over-molded on the driven gear.

3. The prophy angle of claim 1, where in the said prophy cup/brush-head has a largest diameter of 7 mm to 8 mm.

4. The prophy angle of claim 1, wherein extrusion molded socket has an inner diameter of 4 mm to 6 mm, which secures the gear of prophy cup/brush-head in place, while at the same time, provides enough flexibility for rotation.

5. The prophy angle of claim 1, wherein the said extrusion molded socket has a thickness of 0.8 mm to 1 mm.

6. The prophy angle of claim 1, wherein the drive shaft gear and driven rotor gears are bevel gears.

7. The prophy angle of claim 1, wherein said drive shaft gear has 9 to 10 drive shaft gear teeth.

8. The prophy angle of claim 1, wherein said driven rotor gear has 10 to 11 driven rotor gear teeth.

9. The prophy angle of claim 1, wherein the driving shaft is locked in place by a horseshoe-like locker, said horseshoe-like locker having two forks perpendicular to a central axis of the longitudinal section of said housing, with a separation gap between the two forks being greater than the diameter of said drive shaft, and said horseshoe-like locker located through a slot on said tubular housing between two positioning steps of said driveshaft.

10. The prophy angle of claim 1, wherein the drive shaft is connected to said driven rotor at a gear connection, said drive shaft being at an angle of 90 to 120 degrees with respect to a driven rotor axis.

11. The prophy angle of claim 1, wherein said driven rotor is positioned so as to permit coupling of said driven rotor to the prophy cup/brush-head at a distal end of said driven rotor.
